(19) United States
(12) Patent Application Publication
(10) Pub. No.: US 2026/0166692 A1
(43) Pub. Date: Jun. 18, 2026

(54) DOUBLE-HEAD RATCHET TOOL

(71) Applicant: YUNG-TSUNG CHANG, Taichung City (TW)

(72) Inventor: YUNG-TSUNG CHANG, Taichung City (TW)

(21) Appl. No.: 18/982,253

(22) Filed: Dec. 16, 2024

(51) Int. Cl. B25B 23/00; B25B 13/46; B25B 13/48

(52) U.S. Cl. CPC B25B 23/0028; B25B 13/462; B25B 13/481; B25B 23/0035

(57) ABSTRACT

A double-head ratchet tool is provided, wherein the double-head ratchet tool includes: a main body including first and second end portions; a first drive head including a first base and a first ratchet member, the first base being swingably disposed on the first end portion and swingable about a first pivot axis, the first ratchet member being rotatably disposed on the first base and rotatable about a first rotation axis intersecting the first pivot axis; and a second drive head including a second base and a second ratchet member, the second base being swingably disposed on the second end portion and swingable about a second pivot axis, the second pivot axis being transverse to the first pivot axis, the second ratchet member being rotatably disposed on the second base and rotatable about a second rotation axis being not to intersect with the second pivot axis.

### BACKGROUND OF THE INVENTION

### Field of the Invention

The present invention relates to a driving tool, particularly to a double-head ratchet tool.

### Description of the Prior Art

Ratchet tools allow users to rotate fasteners such as screws, bolts, nuts, etc., in narrow spaces by moving their hands back and forth. The ratchet tool, with a ratchet mechanism as its core component, can rotate fasteners in a preset driving direction while not rotating them in the opposite direction. This significantly reduces the required operational clearance and eliminates frequent repositioning of the tool to perform the rotation, thereby effectively improving work efficiency.

However, conventional ratchet tools commonly include a single head with a ratchet mechanism fixed at an end of the handle. This design limits flexibility and adaptability, offering less variability in operation and making it unsuitable for diverse environments.

The present invention is, therefore, arisen to obviate or at least mitigate the above-mentioned disadvantages.

### SUMMARY OF THE INVENTION

The main object of the present invention is to provide a double-head ratchet tool which adapts to a variety of usage angles and operational requirements.

To achieve the above and other objects, a double-head ratchet tool is provided, wherein the double-head ratchet tool includes: a main body including a first end portion and a second end portion opposite to each other; a first drive head including a first base and a first ratchet member, the first base being swingably disposed on the first end portion and swingable about a first pivot axis, the first ratchet member being rotatably disposed on the first base and rotatable about a first rotation axis, the first rotation axis intersecting the first pivot axis; and a second drive head including a second base and a second ratchet member, the second base being swingably disposed on the second end portion and swingable about a second pivot axis, the second pivot axis being transverse to the first pivot axis, the second ratchet member being rotatably disposed on the second base and rotatable about a second rotation axis, the second rotation axis being not to intersect with the second pivot axis.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is a schematic view showing a second drive head in swinging of the exemplary embodiment of the present invention;

FIG. 4 is a schematic view showing a first drive head in swinging of the exemplary embodiment of the present invention;

FIGS. 5 and 6 are schematic view showing operation states of the exemplary embodiment of the present invention;

FIG. 7 is a schematic view showing an insertion rod and the second drive head in a detached state according to an exemplary embodiment of the present invention;

FIG. 8 is a schematic view showing the insertion rod and the second drive head in an assembled state according to an exemplary embodiment of the present invention;

FIG. 9 is a schematic view showing a second blocking portion and a second ratchet member blocked with each other according to an exemplary embodiment of the present invention; and

FIG. 10 is a schematic view showing a second adapter inserted in the second ratchet member according to an exemplary embodiment of the present invention.

### DETAILED DESCRIPTION OF THE PREFERRED EMBODIMENTS

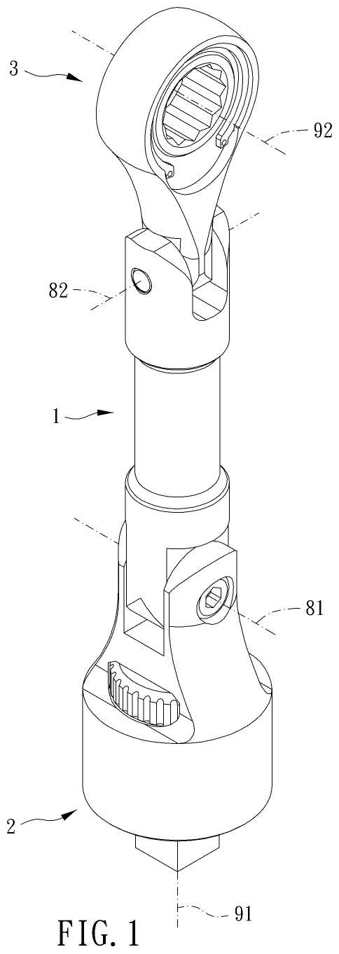

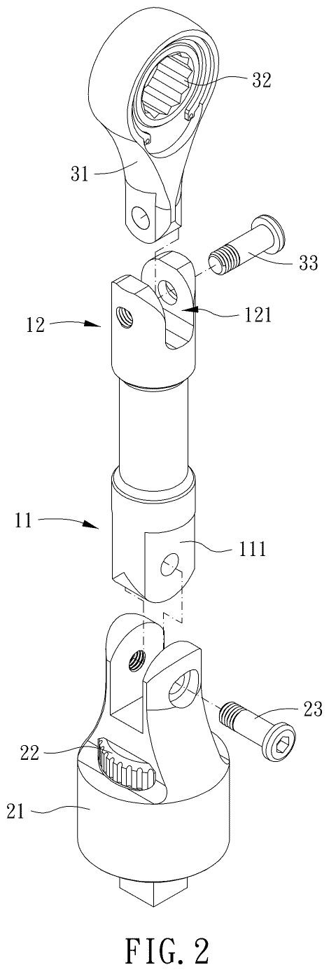

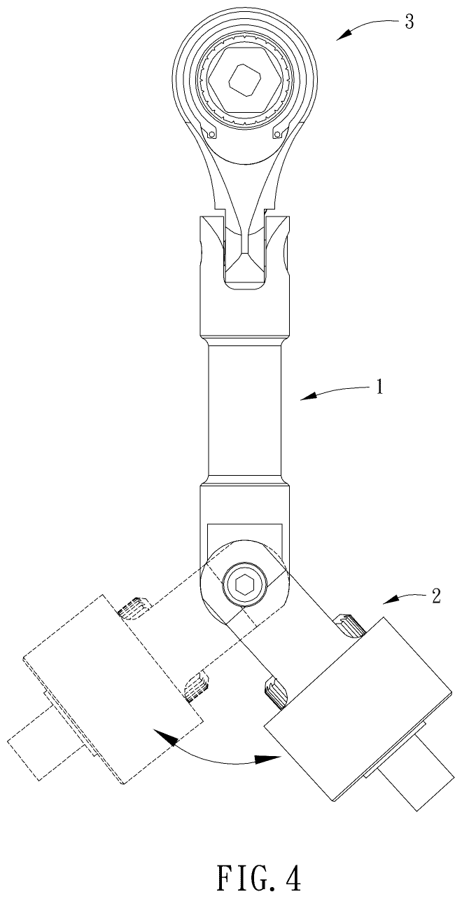

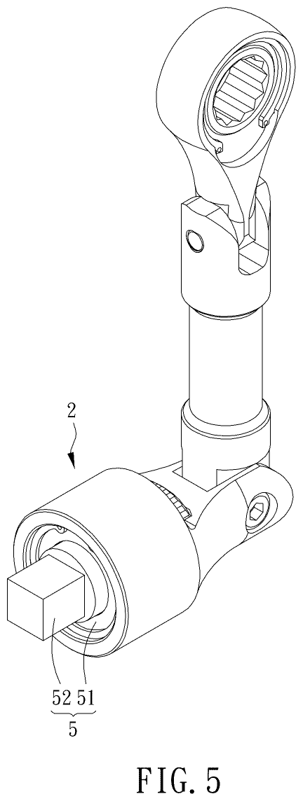

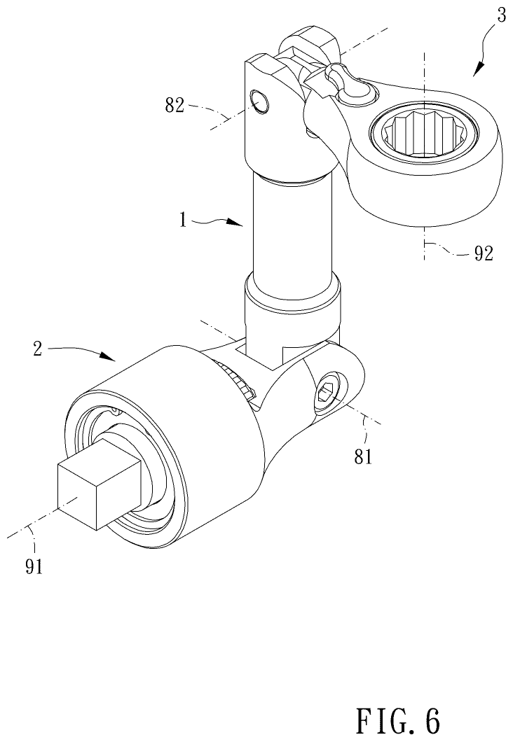

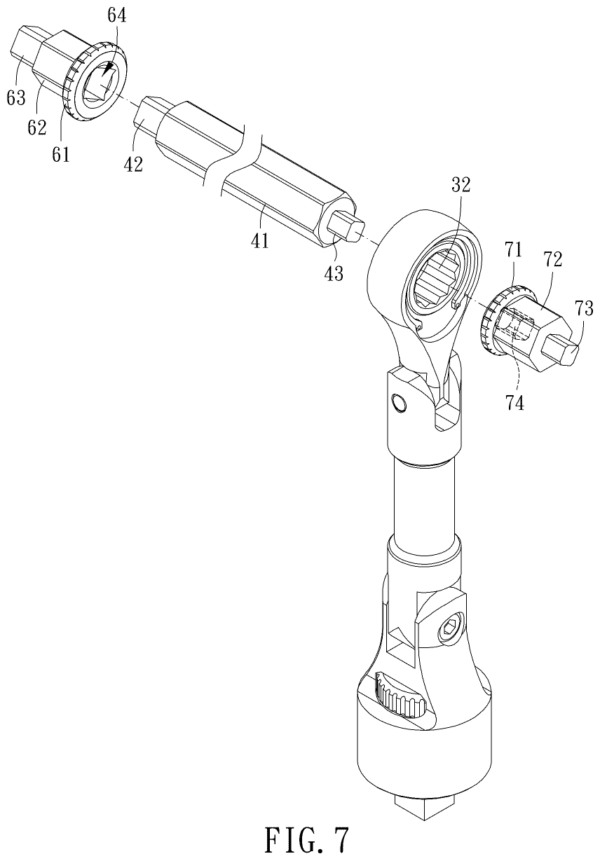

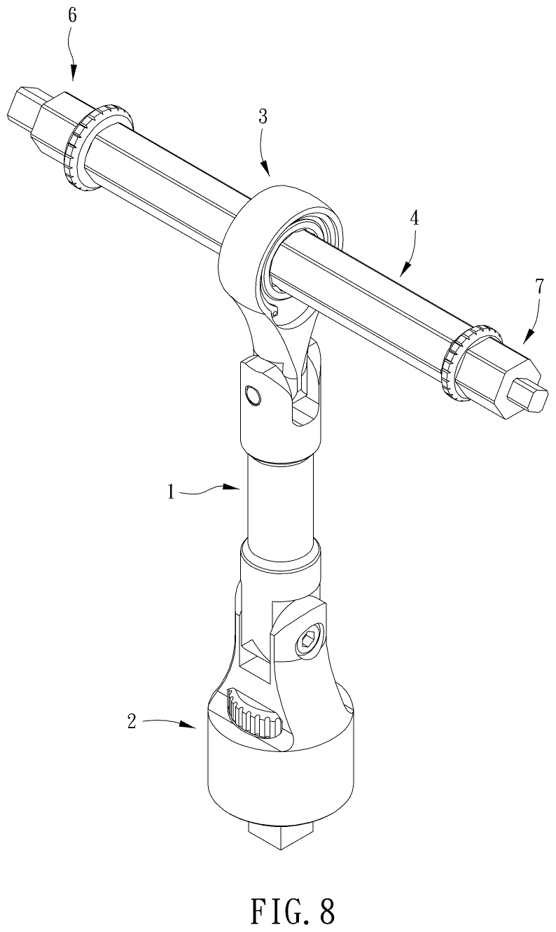

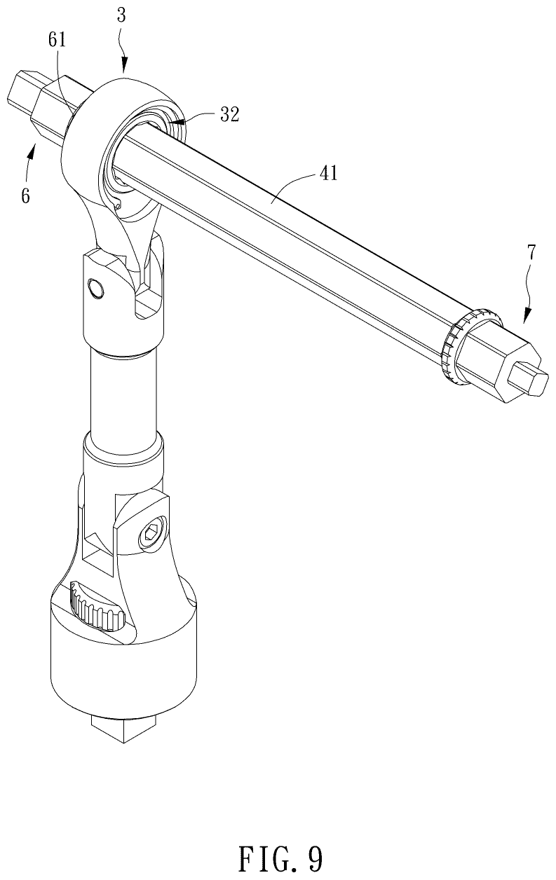

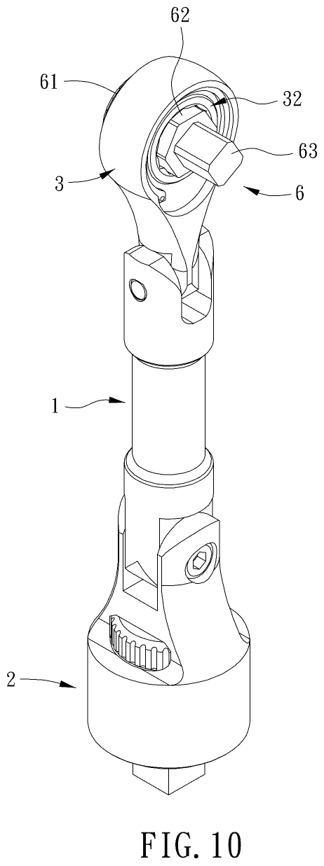

Please refer to FIGS. 1 to 10 for an exemplary embodiment of the present invention. A double-head ratchet tool of the present invention includes a main body 1, a first drive head 2, and a second drive head 3.

The main body 1 includes a first end portion 11 and a second end portion 12 opposite to each other. The first drive head 2 includes a first base 21 and a first ratchet member 22. The first base 21 is swingably disposed on the first end portion 11 and swingable about a first pivot axis 81. The first ratchet member 22 is rotatably disposed on the first base 21 and rotatable about a first rotation axis 91. The first rotation axis 91 intersects the first pivot axis 81. The second drive head 3 includes a second base 31 and a second ratchet member 32. The second base 31 is swingably disposed on the second end portion 12 and swingable about a second pivot axis 82. The second pivot axis 82 is transverse to the first pivot axis 81. The second ratchet member 32 is rotatably disposed on the second base 31 and rotatable about a second rotation axis 92. The second rotation axis 92 does not intersect the second pivot axis 82.

The swing directions of the first drive head 2 and the second drive head 3 are different, allowing for various swing angles to be applied. With the differing rotational directions of the first ratchet member 22 and the second ratchet member 32, more diverse usage combinations can be achieved, making it applicable in various environments.

Preferably, one of the first end portion 11 and the second end portion 12 includes an assembling space 121, and an other of the first end portion 11 and the second end portion 12 includes two flat surfaces 111 on its outer surface. One of the first base 21 and the second base 31 is swingably inserted in the assembling space 121, and an other of the first base 21 and the second base 31 is swingably disposed between the two flat surfaces 111. The first end portion 11 and the second end portion 12 are configured with male and female structures, respectively, to be connected to the first base 21 and the second base 31. This design not only allows the assembler to quickly assemble the components but also ensures that the main body 1 maintains a certain structural strength.

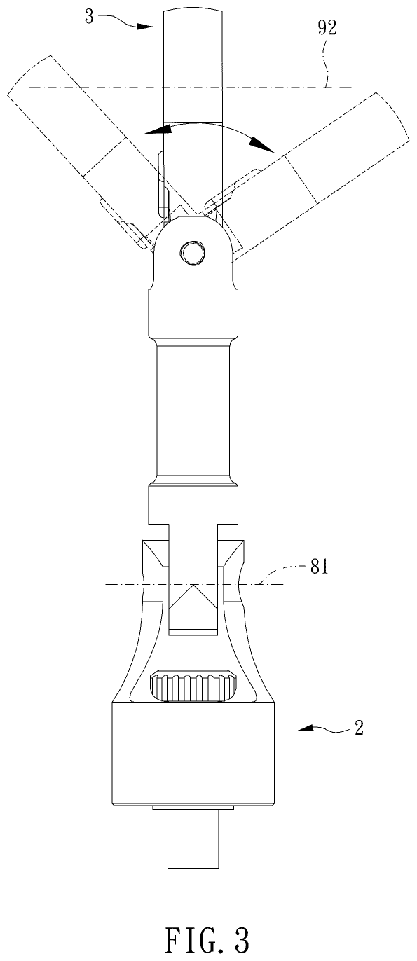

In this embodiment, the first drive head 2 further includes a first shaft 23 which is connected to the first base 21 and the first end portion 11 in the first pivot axis 81. Similarly, the second drive head 3 includes a second shaft 33 which is connected to the second base 31 and the second end portion 12 in the second pivot axis 82. As shown in FIG. 3, when the second rotation axis 92 is parallel to the first pivot axis 81, the second drive head 3 does not protrude beyond the first drive head 2 in the extension direction of the first pivot axis 81. The differences in thickness and dimensions of the structures provide users with various options for operation.

Specifically, the first drive head 2 further includes a first adapter 5 which is disposed on the first ratchet member 22, centered on the first rotation axis 91 and rotatable with the first ratchet member 22. The first adapter 5 is configured to be connected to a rotatable component such as a socket wrench. In this embodiment, the first adapter 5 includes a first body portion 51 and a first head portion 52. The first body portion 51 is embedded in the first base 21 and connected to the first ratchet member 22. The first head portion 52 projects from the first base 21. The first base 21 ensures that the first ratchet member 22 rotates smoothly without interference from external elements.

Specifically, the double-head ratchet tool further includes an insertion rod 4 and a second adapter 6. The insertion rod 4 is detachably inserted in the second ratchet member 32 and is rotatable with the second ratchet member 32. The second adapter 6 is disposed on the insertion rod 4. In this configuration, two exemplary usage modes may be provided as follows. Mode 1: Similar to using an L-bar, the insertion rod 4 allows the second adapter 6 to extend deeply into a confined space to engage a fastener as such the user may hold the main body 1 and drive the insertion rod 4 via the second ratchet member 32. Mode 2: Similar to using a T-bar, the first adapter 5 engages the fastener, and the user holds the insertion rod 4 to drive the main body 1 for rotation.

Preferably, the double-head ratchet tool further includes a third adapter 7. The second adapter 6 and the third adapter 7 are disposed on opposite sides of the insertion rod 4. The size of the second adapter 6 differs from the size of the third adapter 7, thereby providing a plurality of sizes for users to select.

Preferably, at least one of the second adapter 6 and the third adapter 7 is detachably assembled to the insertion rod 4. This allows the user to replace them with different sizes, configurations, or other compatible adapters as required.

Preferably, the second adapter 6 and the third adapter 7 are respectively blockable by the second drive head 3 in the second rotation axis 92, effectively preventing the insertion rod 4 from detaching from the second ratchet member 32.

Specifically, the second adapter 6 includes a second blocking portion 61, a second body portion 62, a second head portion 63, and a second insertion hole 64. The second head portion 63 projects coaxially from the second body portion 62. The second blocking portion 61 projects transversely from the second body portion 62 on a side remote from the second head portion 63 and is blockable by the second ratchet member 32. The second insertion hole 64 extends coaxially from the second body portion 62 in a direction away from the second head portion 63 toward the second head portion 63. The third adapter 7 includes a third blocking portion 71, a third body portion 72, a third head portion 73, and a third insertion hole 74. The third head portion 73 projects coaxially from the third body portion 72. The third blocking portion 71 projects transversely from the third body portion 72 on a side remote from the third head portion 73 and is blockable by the second ratchet member 32. The third insertion hole 74 extends coaxially from the third body portion 72 in a direction away from the third head portion 73 toward the third head portion 73.

Specifically, the sizes of the first head portion 52, the second head portion 63 and the third head portion 73 are different, thereby fully providing various sizes for user selection. The insertion rod 4 includes a body portion 41, a second connector 42, and a third connector 43. The body portion 41 extends linearly, and the second connector 42 and the third connector 43 axially project from opposite ends of the body portion 41. The second connector 42 is detachably inserted in the second insertion hole 64, and the third connector 43 is detachably inserted in the third insertion hole 74.

Preferably, the second adapter 6 and the third adapter 7 are detachably inserted in the insertion rod 4 and are also detachably inserted in the second ratchet member 32, thereby providing users with more various usage combinations. Preferably, the size of the second body portion 62 is identical to that of the third body portion 72, and each of the second body portion 62 and the third body portion 72 is insertable in the second ratchet member 32.

Preferably, the outer contour of the second body portion 62, the outer contour of the third body portion 72 and the outer contour of the insertion rod 4 are polygonal, which facilitates cooperation with various tools.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A double-head ratchet tool including:
a main body including a first end portion and a second end portion opposite to each other;
a first drive head including a first base and a first ratchet member, the first base being swingably disposed on the first end portion and swingable about a first pivot axis, the first ratchet member being rotatably disposed on the first base and rotatable about a first rotation axis, the first rotation axis intersecting the first pivot axis; and
a second drive head including a second base and a second ratchet member, the second base being swingably disposed on the second end portion and swingable about a second pivot axis, the second pivot axis being transverse to the first pivot axis, the second ratchet member being rotatably disposed on the second base and rotatable about a second rotation axis, the second rotation axis being not to intersect with the second pivot axis.

2. The double-head ratchet tool of claim 1, wherein when the second rotation axis is parallel to the first pivot axis, the second drive head is not protrusive beyond the first drive head in a direction of the first pivot axis.

3. The double-head ratchet tool of claim 1, wherein one of the first end portion and the second end portion includes an assembling space, an other of the first end portion and the second end portion includes two flat surfaces on an outer surface thereof, one of the first base and the second base is swingably inserted in the assembling space, and an other of the first base and the second base is swingably disposed between the two flat surfaces.

4. The double-head ratchet tool of claim 1, wherein the first drive head further includes a first adapter, and the first adapter is disposed on the first ratchet member, centered on the first rotation axis, and rotatable with the first ratchet member.

5. The double-head ratchet tool of claim 1, further including an insertion rod and a second adapter, wherein the insertion rod is detachably inserted in and rotatable with the second ratchet member, and the second adapter is disposed on the insertion rod.

6. The double-head ratchet tool of claim 5, further including a third adapter, wherein the second adapter and the third adapter are disposed on opposite ends of the insertion rod, and the size of the second adapter differs from the size of the third adapter.

7. The double-head ratchet tool of claim 6, wherein at least one of the second adapter and the third adapter is detachably assembled to the insertion rod.

8. The double-head ratchet tool of claim 7, wherein the second adapter and the third adapter are blockable by the second drive head in a direction of the second rotation axis, respectively.

9. The double-head ratchet tool of claim 8, wherein each of the second adapter and the third adapter is detachably inserted in the insertion rod or is detachably inserted in the second ratchet member.

10. The double-head ratchet tool of claim 2, wherein one of the first end portion and the second end portion includes an assembling space, an other of the first end portion and the second end portion includes two flat surfaces on an outer surface thereof, one of the first base and the second base is swingably inserted in the assembling space, and an other of the first base and the second base is swingably disposed between the two flat surfaces; the first drive head further includes a first adapter, and the first adapter is disposed on the first ratchet member, centered on the first rotation axis, and rotatable with the first ratchet member; the double-head ratchet tool further includes an insertion rod, a second adapter and a third adapter, the insertion rod is detachably inserted in and rotatable with the second ratchet member, the second adapter is disposed on the insertion rod, the second adapter and the third adapter are disposed on opposite ends of the insertion rod, and the size of the second adapter differs from the size of the third adapter, at least one of the second adapter and the third adapter is detachably assembled to the insertion rod, the second adapter and the third adapter are blockable by the second drive head in a direction of the second rotation axis, respectively, and each of the second adapter and the third adapter is detachably inserted in the insertion rod or is detachably inserted in the second ratchet member; the first drive head further includes a first shaft, the first shaft is connected to the first base and the first end portion in the direction of the first pivot axis; the second drive head further includes a second shaft, and the second shaft is connected to the second base and the second end portion in the direction of the second pivot axis; the first adapter includes a first body portion and a first head portion, the first body portion is embedded in the first base and connected to the first ratchet member, and the first head portion projects from the first base; the second adapter includes a second blocking portion, a second body portion, a second head portion and a second insertion hole, the second head portion projects coaxially from the second body portion, the second blocking portion projects transversely from the second body portion on a side remote from the second head portion and is blockable by the second ratchet member, and the second insertion hole extends coaxially from the second body portion in a direction away from the second head portion toward the second head portion; the third adapter includes a third blocking portion, a third body portion, a third head portion and a third insertion hole, the third head portion projects coaxially from the third body portion, the third blocking portion projects transversely from the third body portion on a side remote from the third head portion and is blockable by the second ratchet member, and the third insertion hole extends coaxially from the third body portion in a direction away from the third head portion toward the third head portion; the insertion rod includes a body portion, a second connector and a third connector, the body portion extends linearly, the second connector and the third connector project axially from opposite ends of the body portion, and the second connector is detachably inserted in the second insertion hole, and the third connector is detachably inserted in the third insertion hole; each of the second body portion and the third body portion is insertable in the second ratchet member; outer contours of the second body portion, the third body portion and the insertion rod are polygonal; the sizes of the first head portion, the second head portion and the third head portion are different; the sizes of the second body portion and the third body portion are identical.
